(19) United States
(12) Patent Application Publication
(10) Pub. No.: US 2013/0295830 A1
(43) Pub. Date: Nov. 7, 2013

(54) Swivel spike cone

(71) Applicants: Kathleen Harden, Dunlap, TN (US); Scott Christopher Neal, Sturbridge, MA (US); Jeffrey Allen Harden, Dunlap, TN (US); Darren Keith Perry, Buchanan, GA (US)

(72) Inventors: Kathleen Harden, Dunlap, TN (US); Scott Christopher Neal, Sturbridge, MA (US); Jeffrey Allen Harden, Dunlap, TN (US); Darren Keith Perry, Buchanan, GA (US)

(21) Appl. No.: 13/506,594

(22) Filed: May 2, 2012

(51) Int. Cl. A22C 21/00

(52) U.S. Cl. 452/165

(57) ABSTRACT

An apparatus for suspending the poultry front half frame on a poultry processing line leaving fewer ribs. An apparatus utilizing spikes strategically located on the cone. Attached at the base of the Swivel Spike Cone is a swivel mechanism that enables the poultry front half frame to rotate 360 degrees when attached to the post located on the chain that moves the birds up the processing line. The present invention uses strategically located spikes allowing for various sizes of birds in the industry. Currently being used in Processing Plants is a smooth surfaced cone that requires the ribs to be left on the poultry front half frame. If the poultry ribs were removed while using these smooth cones it would simply fall off. By enabling poultry processing plants to take off the ribs (leaving them attached to the leg quarters) the leg quarters weigh more, creating additional revenue.

### BACKGROUND OF THE INVENTION

1. Field of the Invention

The present invention relates to an apparatus for suspending the poultry front halve frame leaving fewer, (if any) ribs left on the bird. More specifically, the invention utilizes spikes strategically located on the cone. Attached at the base of the Swivel Spike Cone is a swivel mechanism that enables the attached poultry front half frame to rotate 360 degrees.

2. Description of the Prior Art

There are no prior inventions for the cone. The present Swivel Spike Cone invention is unique from any prior art. The present invention uses strategically located spikes allowing for various sizes of birds in the industry. Currently being used in Poultry Processing Plants is a smooth surfaced cone that requires the ribs to be left on the poultry front half frame. If the poultry ribs were removed while using these slick cones it would simply fall off and on the floor unable to be processed. By enabling poultry processing plants to take off the ribs (leaving them attached to the leg quarters) the leg quarters weigh more. If the ribs were processed though with the poultry front half frame they would be removed at the end of process and ground for soup parts which is less profitable than leg quarters.

The additional benefit not found in the mechanical de-bone (Cone Line) market is that the damaged poultry front halves frame that cannot be processed can now be processed with this Swivel Cone because it will hold fast the front halves with bone or tissue damage.

This swivel mechanism is unique in itself as there are “No” traditional cones on the market today which offer a 360° rotation which allows the rotating cone to mimic the standard process while tapered holding spikes hold the poultry front half frame firm.

### SUMMARY OF THE INVENTION

It is the object of the present invention to provide an apparatus for suspending the poultry front half frame leaving fewer, (if any) ribs left on the bird. More specifically, the inventor has discovered an apparatus which uses spikes strategically located on the cone along with a swivel mechanism attached at the base of the Swivel Spike Cone enables the attached poultry front half frame to rotate 360 degrees through processing.

Currently being used in Poultry Processing Plants is a smooth surfaced cone that requires the ribs to be left on the poultry front half frame. If the poultry ribs were removed while using these smooth cones it would simply fall off and on the floor unable to process. By enabling poultry processing plants to take off the ribs (leaving them attached to the leg quarters) the leg quarters would weigh more. If the ribs were processed through with the poultry front half frame they would be removed at the end of process and ground for soup parts which is less profitable than leg quarters.

The current process (using the smooth cones) in which poultry moves through a processing plant after the slaughter begins with the cut up department. The cut up department currently removes the leg quarters leaving all the ribs in the poultry front half frame. Utilizing the current invention, Swivel Spike Cone, the

Cut up department can remove all ribs with the leg quarters. The poultry front half frame is then sent to the cone line.

The next process is the cone loaders which load the poultry front half frame onto the cones. The current process being used in the processing plants once the poultry front half frame has been loaded onto the smooth cone is as follows:

Four shoulder cutters perform initial shoulder cut. (Some plants cut shoulders and wings together)

Wing Rounder—cut the wings if the shoulder cutter does not remove them.

Breast Pullers (two per line)—remove breast from carcass and check for bones.

Tender scorers (two per line)—score tender prior to removal

Tender Pullers (two per line)—pull the tenders.

Frame is left spent and unloaded automatically at the end of the line onto frame belt which goes To the Grinders.

The same process listed above using the invention (Swivel Spike Cone) will significantly enhance the yield value by leaving all the ribs on the leg quarters which equals millions of dollars per year in added revenue to the Processing plants by adding the weight to a more valuable product.

Utilizing the Swivel Spike Cone—the first process after slaughter (the cut up department) will remove the leg quarter with ribs attached. The spikes on the swivel spike cone are strategically located, allowing for various sizes of birds to be processed. Utilizing the swivel mechanism, the rotating cone mimics standard processing using smooth cones while tapered spikes hold the poultry front half frame firm on the cone. Currently used smooth cone combined with moisture content of poultry frame when loaded on smooth cone allows for lower co-efficient of friction and effortless rotation of the Poultry Front Half frame. This rotation is now accomplished by using the 360 degree swivel mechanism. Since the ribs are left on the leg quarters at the beginning of the process, less frame is sent to the grinders which realize higher revenue for leg quarters.

### BRIEF DESCRIPTION OF THE DRAWINGS

FIG. 1 is a side view of the spike of the present invention.

FIG. 2 is a side view of the swivel spike cone of the present invention.

FIG. 3 is the top view of the swivel spike cone of the present invention.

FIG. 4 is the bottom view of the swivel spike cone and swivel mechanism of the present invention.

FIG. 5 is the side view of the swivel mechanism located on the bottom of the present invention.

FIG. 6 is a side view of the swivel spike cone attached to the post which it rides on during the poultry processing phase.

### DETAILED DESCRIPTION OF THE INVENTION

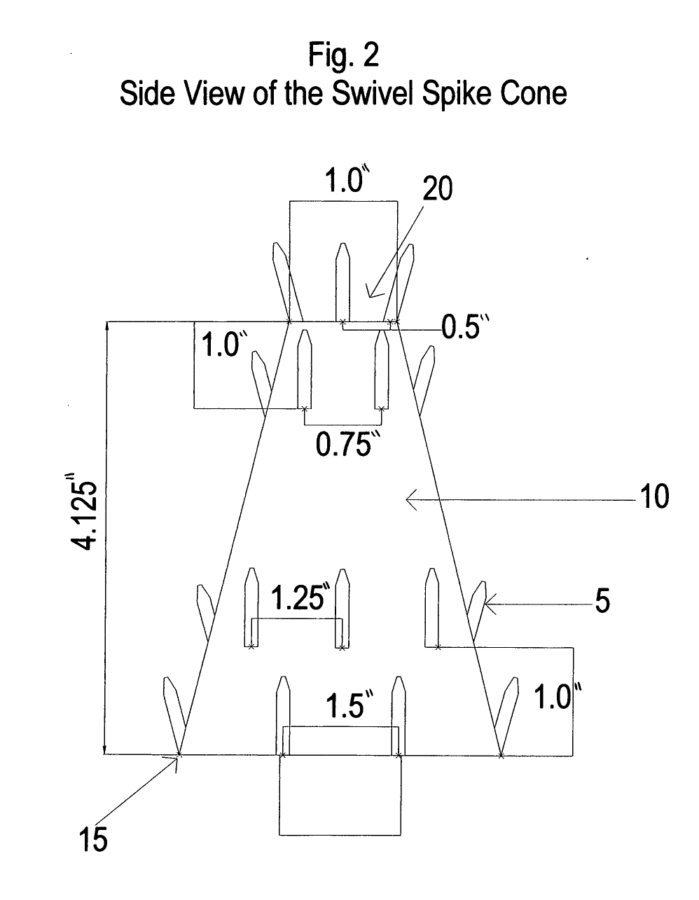

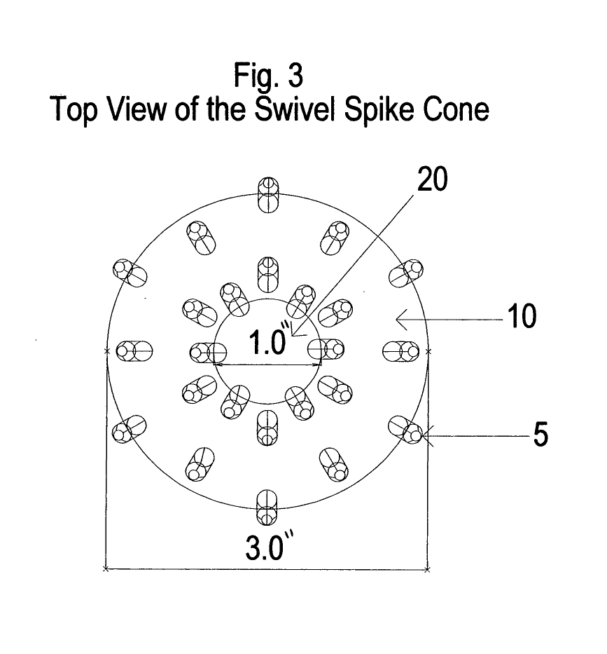

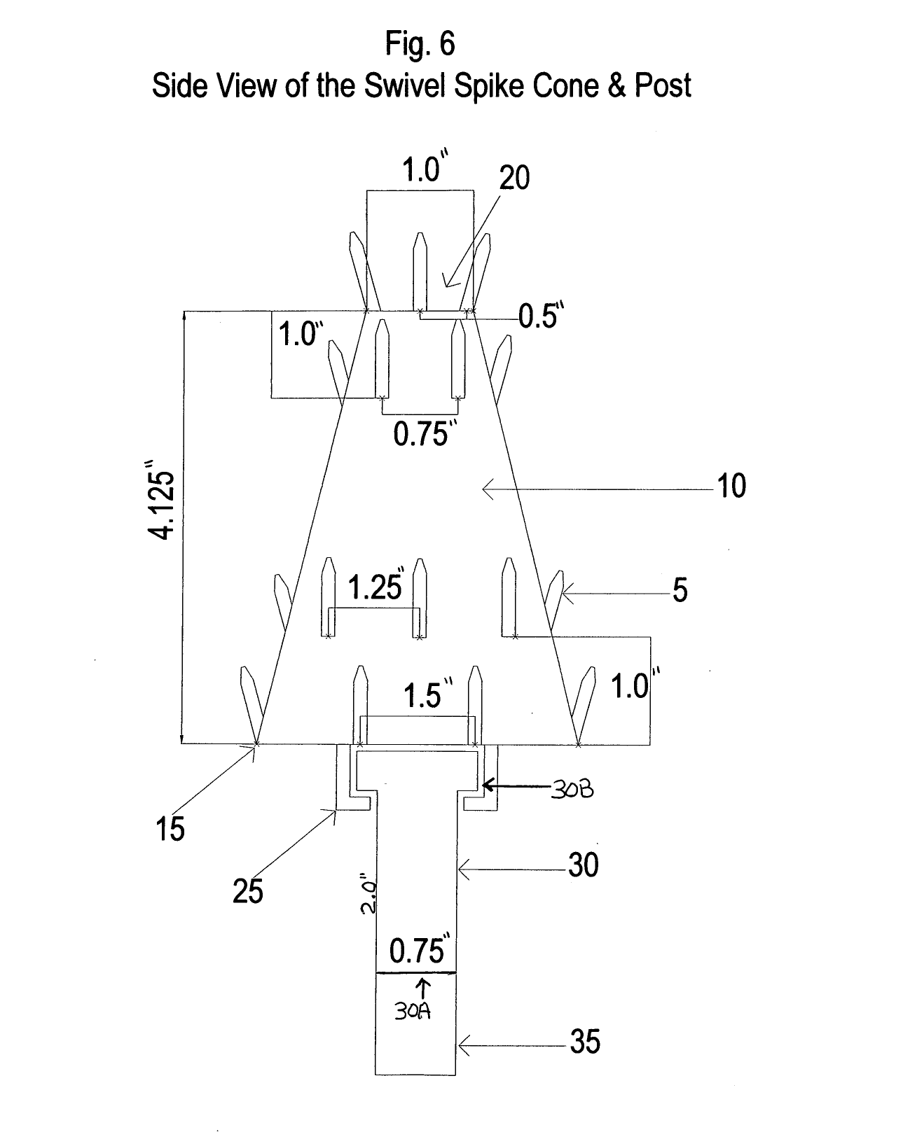

Referring to FIGS. 2 and 6 the apparatus shown is the side of the Swivel Spike Cone and is represented by the reference numeral 10. Apparatus 10 has the dimensions: height of 4.125 inches, top width (reference numeral 20) of 1 inch, and a bottom width (reference numeral 15) or diameter of 3 inches as shown in FIGS. 3, 4 and 5. The shape of this apparatus is the shape of a cone.

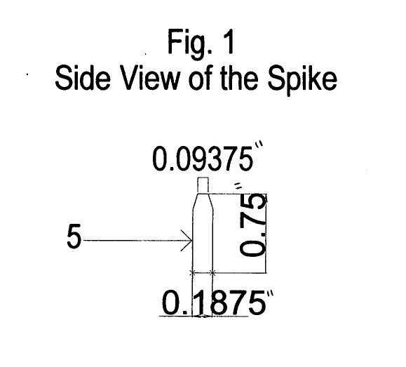

Referring to FIGS. 1, 2, 3, 4, and 6 the apparatus shown is a spike used to hold the Poultry's front half frame of the poultry (not shown) on the Swivel Spike Cone and is represented by reference numeral 5. Since the ribs are left on the leg quarters at the beginning of the process, less Poultry frame is sent to the grinders which realize higher revenue for leg quarters. Without the spikes the Poultry front half frame would simply fall off and onto the floor unable to be processed. Apparatus 5 has the dimensions: height of 0.75 inches, bottom width of 0.1875 inches, and top width of 0.09375 inches as shown in FIG. 1. The spikes are set at spacing intervals on the side of the Swivel Spike Cone as shown on FIGS. 2 and 6. The bottom spikes are set at an interval of 1.5 inches and placed around the bottom 15 circumference of the cone. The next row of spikes is spaced at 1.25 inches. The next row of spike the spacing is 0.75 inches. The top row of spikes is spaced at a 0.5 inch interval and placed around the circumference of the top of the cone 20. In some cases the top row of spikes are omitted for processing purposes. The spike of the current invention is not limited to the quantity, size or positioning which is discussed above, and can be varied in numerous ways within the scope of the appended claims. It should be appreciated by those skilled in the art that various modifications and variations can be made in the present invention without departing from the spirit and scope of the invention. Some applications might require minor adjustment to the number of spikes used and positioning of spikes.

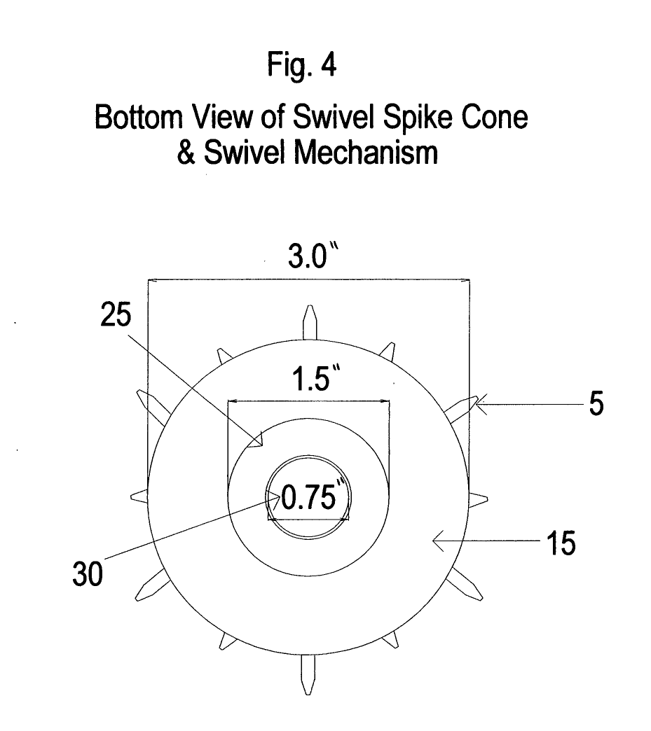

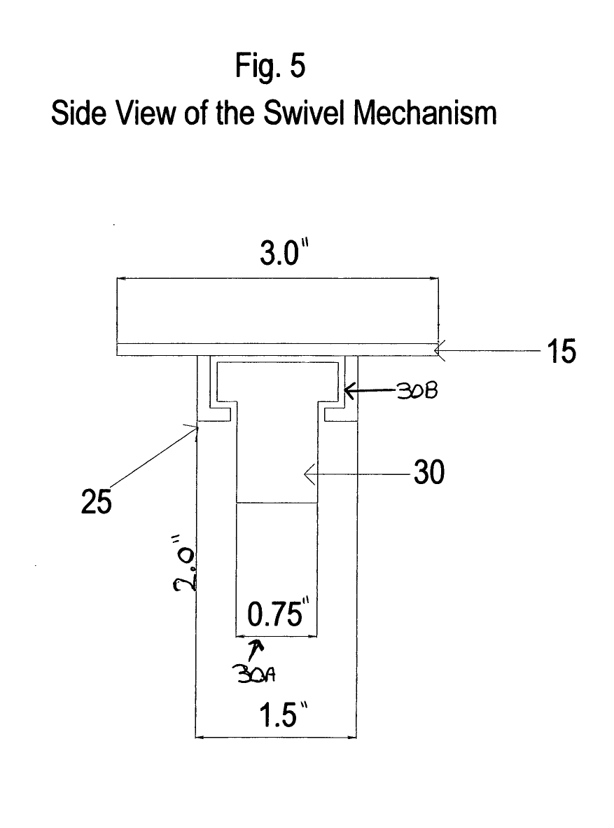

Referring to FIG. 4 the apparatus shown is the bottom of the Swivel Spike Cone and Swivel Mechanism. The bottom of the cone 15 can be flat or concave. The outside width of swivel mechanism (reference numeral 25) is 1.5 inches. The inside diameter of the swivel mechanism (reference numeral 30) is 0.75 inches. Inside 30 and outside 25 widths can be seen in FIGS. 5 and 6. The Swivel Mechanism is free moving for the operator to manipulate as needed. A locking pin (not shown) can be used if the process requires it to be rigid (non swivel). Referring to FIG. 5 and reference numeral 30b the inside diameter 25 is free moving inside of the outside diameter 30 allowing for 360 degree rotating action.

Referring to FIGS. 5 and 6 the side of the Swivel Mechanism is shown. The bottom of the cone 15 is attached to the outside diameter 25 of the Swivel Mechanism, which in turn surrounds the inside diameter 30 of the Swivel Mechanism. The base of the inside diameter of the swivel mechanism 30 is joined by a tig weld (reference numeral 30a) to the top of the post (reference numeral 35). Standard length of the Swivel mechanism is 2 inches as shown in FIGS. 5 and 6. The standard length of the post (not shown) is approximately 8 inches. The length of the inside diameter of the Swivel Mechanism 30 and the length of the post 35 can be varied according to process requirements. The base of the post 35 (not shown) is connected to a conveyor which carries the post with the attached Swivel Spike Cone through the process. The process is as follows:
Four shoulder cutters perform initial shoulder cut. (Some plants cut shoulders and wings together)
Wing Rounder—cut the wings if the shoulder cutter does not remove them.
Breast Pullers (two per line)—remove breast from carcass and check for bones.
Tender scorers (two per line)—score tender prior to removal
Tender Pullers (two per line)—pull the tenders.
Frame is left spent and unloaded automatically at the end of the line onto frame belt which goes To the Grinders.

As the product goes through the processes on the Swivel Spike Cone operators are allowed to manipulate the product as needed because of the 360 degree rotation of the Swivel Mechanism (reference numeral 25, 30 and 30a) shown in FIGS. 4, 5, and 6. If the process requires no rotation, a locking pin (not shown) can be used to make the apparatus rigid (non swivel).

Construction Materials

Unit may be constructed of any approved (particularly USDA approved materials) such as stainless steel or USDA approved thermoplastics. Particularly preferred is 304 gauge stainless steel for the Swivel Spike Cone. For use to process chicken, the approximate size of unit is about 4.125 inches in height, 3 inches wide at the base, and 1 inch at the top. The approximate size of the Swivel Mechanism is 1.5 inches for the outside diameter, 0.75 inch for the inside diameter, and 2 inches long. Larger sizes may be selected if the animal being processed is larger (e.g., pork, beef, lamb, game, large poultry, etc.)

The invention is not limited to the embodiment which is discussed above, and can be varied in numerous ways within the scope of the appended claims. It should be appreciated by those skilled in the art that various modifications and variations can be made in the present invention without departing from the spirit and scope of the invention.

We claim:

1. A poultry processing cone that allows the poultry front half frame to be processed in the processing plant without the ribs attached to the frame (leaving them attached to the leg quarters).

2. The poultry processing cone of claim 1 has a mechanical swivel located on the bottom of the cone allowing the cone to swivel 360 degrees. The rotating cone mimics standard processing using smooth cones while tapered spikes hold the poultry front half frame firm on the cone.

3. The poultry processing cone of claim 1 has spikes strategically located on the cone. This allows the cone to be used on various sizes of poultry. The spikes are not limited to quantity or position it should be appreciated by those skilled in the art that various modifications and variations can be made in the present invention without departing from the spirit and scope of the invention.
